(19) United States
(12) Patent Application Publication
(10) Pub. No.: US 2007/0128314 A1
(43) Pub. Date: Jun. 7, 2007

(54) Method for producing rapid fermented type Miso-like food material with favorable taste and flavor

(75) Inventors: Naoko Hishiya, Kawasaki-shi (JP); Mamoru Watanabe, Kawasaki-shi (JP); Michinari Sakurai, Kawasaki-shi (JP); Kaname Fujita, Kawasaki-shi (JP); Toshihiro Noda, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO. INC, Tokyo (JP)

(21) Appl. No.: 11/523,557

(22) Filed: Sep. 20, 2006

(30) Foreign Application Priority Data
Sep. 21, 2005 (JP) 2005-273469

(51) Int. Cl. A23L 1/20

(52) U.S. Cl. 426/46

(57) ABSTRACT

A rapid fermented type salt-free Miso-like food material which is favorable in taste and flavor, which has a strong umami, rich taste, thickness, and mouthfullness, and a reduced stuffy smell or astringent taste may be prepared in a method including: adding a Koji mold and a bacteriocin-producing lactic acid bacterium culture fluid or a supernatant thereof to a food material; making Koji in a hermetically sealed Koji-making equipment while continuously or intermittently supplying clean air; mixing the bacteriocin-producing lactic acid bacterium culture fluid or the supernatant thereof with the thus-resulting Koji, and further mixing one or more food materials as needed in an amount of 0.01 to 50 times weight of the Koji; forming a moromi-mash by making a paste from the mixture; and then hydrolyzing the moromi-mash in the absence of common salt, by adding any one of an alcoholic liquor, yeast, and dextrin to the Koji.

### CROSS REFERENCES TO RELATED APPLICATIONS

This application claims priority to Japanese Patent Application No. 273469/2005, filed on Sep. 21, 2005, which is incorporated herein by reference in its entirety.

### BACKGROUND OF THE INVENTION

1. Field of the Invention

The present invention relates to methods for producing a salt-free Miso-like food material being favorable in taste and flavor, which can be used as a novel material for foods or as seasonings, and has strong umami (delicious taste) and rich taste, as well as thickness and mouthfullness. The present invention also relates to Miso-like food materials which are produced by such a method.

2. Discussion of the Background

Miso (fermented soybean paste) is a Japanese traditional food which may be also referred to as a root of fermented foods. However, in recent years, dishes in which Miso is used are predominantly miso soups, as the lifestyle is progressively westernized, and the consumption of such miso soups is on a declining trend. Hence, in order to also raise the demand for Miso as a healthy diet, the development of foods in which Miso is utilized and which fit with contemporary society has been desired. However, Miso includes a significant amount of salinity, and thus, there has been strong anxiety in that a high intake of Miso may lead to consumption of excess amounts of salinity. Accordingly, demand for Miso has been decreasing under current circumstances.

Meanwhile, Miso has been conventionally used in miso soups as well as dressings or a variety of seasonings. As described above, when Miso is intended to be used in various applications, problems may be often caused not only in regard to salinity of the Miso but in various microorganisms, particularly the bacteria belonging to the genus Bacillus that are heat resistant bacteria, and which are inherently present in the Miso. More specifically, because Miso is fermented while being almost exposed to the ambient air during its production, the Miso may be contaminated with various microorganisms. Such microorganisms are not problematic so often in Miso because they do not proliferate therein due to the presence of common salt. However, in the case of the use in dressings and the like, the microorganisms inherently present in the Miso may proliferate in the product, to thereby cause deterioration of the product as the case may be.

Takeo Kato, Shokuhin no Hikanetsu Sakkin Ouyou Handbook (Comprehensive Handbook of Nonthermal Sterilization of Foods) p. 216, July 2001, discloses the development of a totally new Miso-like material for foods in which common salt is not included at all, and intrinsically existing microorganisms, particularly bacteria belonging to the genus Bacillus are reduced to undetectable level, using soybean or the like as a raw material based on the method for producing Miso. This material for foods does not include common salt, and any microorganism is not detected therein. In addition, a higher degree of degradation of proteins has occurred in this material for foods compared to Miso, therefore, the content of amino acids, particularly glutamic acid, is high leading to strong umami, rich taste, thickness, and mouthfullness. However, when soybean is used as a raw material, issues of sensory profile remained, i.e., generation of a strange flavor like stuffed air-dried straw (stuffy smell) and an astringent taste, resulting from fermentation and decomposition of the soybean.

In conventional techniques, examples of methods for producing low-salt Miso or salt-free Miso include a method for producing a food including a high amount of proteins in which diluted and dialyzed low-salt Miso is used (see, JP-A-58-175463); a method for producing desalted Miso by diluting Miso in water (see, JP-A-63-2141542), and the like. Furthermore, a method for preparing salt-free Miso in a laboratory scale is disclosed in which lactic acid fermentation is carried out by inoculating a lactic acid bacterium that produces bacteriocin referred to as nisin (see, Takeo Kato, Shokuhin no Hikanetsu Sakkin Ouyou Handbook (Comprehensive Handbook of Nonthermal Sterilization of Foods) p. 216, July 2001). In this method, it is reported that bacillus and other contaminant bacteria were not detected. However, in production of Miso in an actual industrial scale, merely adding the nisin-producing lactic acid bacterium would result in marked proliferation of a variety of microorganisms contaminated from the ambient air during aging, particularly lactic acid bacteria such as bacteria belonging to the genus Pediococcus, bacteria belonging to the genus Enterococcus, and the like, which may lead to a lowering of the pH due to lactic acid formed by such lactic acid bacteria to thereby cause so-called souring. In other words, preparation of salt-free Miso in a laboratory scale is comparatively easy in terms of controlling the microorganisms, however, control of the saprophytic bacteria is very difficult in production in an industrial scale. In Takeo Kato, Shokuhin no Hikanetsu Sakkin Ouyou Handbook (Comprehensive Handbook of Nonthermal Sterilization of Foods) p. 216, July, 2001, it is described that industrial production of the salt-free Miso is under investigation. However, no specific conditions for the production are disclosed, and further, the making of Koji (rice malt) in a hermetically sealed state is not referred to at all in this publication. Additionally, a method in which Koji is produced using a rotary pressure drum, by subjecting a Koji material to a treatment, i.e., water spray, steam boiling, cooling, and Koji making in single apparatus, is disclosed (see, JP-A-7-107966). According to this method, it is reported that no saprophytic bacteria were found in the resultant Koji. However, JP-A-7-107966 is concerned with a culturing method of Koji and an apparatus therefor, but degradation of moromi-mash in the absence of common salt, i.e., production of salt-free Miso is not referred to at all.

Additionally, improvement of flavor of the Miso-like food materials, in particular, reduction of a stuffy smell or an astringent taste has been scarcely studied. JP-A-2004-33092 discloses a method for improving an acrid taste of a phytoestrogene derivative by subjecting it to a fermentation treatment in the presence of calcium, while JP-B-8-43 discloses a method for suppressing a soybean odor by allowing an enzyme, a lactic acid bacterium, and Propionbacterium, or yeast in addition thereto, to act on powder of a peeled soybean. However, these give no hint on the invention described herein later.

### SUMMARY OF THE INVENTION

Accordingly, it is one object of the present invention to provide novel methods for producing a novel salt-free Miso-like food material which is favorable in taste and flavor, which has a strong umami, rich taste, thickness, and mouthfullness, and a reduced stuffy smell or astringent taste.

It is another object of the present invention to provide novel Miso-like food materials which are prepared by such a process.

It is another object of the present invention to provide novel salt-free Miso-like food materials which are favorable in taste and flavor, which has a strong umami, rich taste, thickness, and mouthfullness, and a reduced stuffy smell or astringent taste.

These and other objects, which will become apparent during the following detailed description, have been achieved by the inventors' discovery that in a method comprising: adding a Koji mold and a bacteriocin-producing lactic acid bacterium culture fluid or a supernatant thereof to a material for a food; making Koji in a hermetically sealed state Koji-making machine while continuously or intermittently supplying clean air; then mixing the bacteriocin-producing lactic acid bacterium culture fluid or the supernatant thereof with the thus-resulting Koji; and further mixing one or more materials for foods as needed in an amount of 0.01 to 50 times weight of the Koji; forming a moromi-mash by making the mixture into a paste form; and subsequently hydrolyzing the moromi-mash in the absence of common salt,

that by adding any one of an alcoholic liquor, yeast and dextrin to the Koji; or by mixing an alcoholic liquor with the moromi-mash, before the hydrolysis, or the hydrolyzed moromi-mash;

or by using a Koji mold belonging to the genus Monascus, a Koji mold belonging to the genus Rhizopus, or a Koji mold belonging to the genus Neurospora as the Koji mold;

or by using faba bean or mung bean or Japanese common chestnut as the material for the food,

a novel rapid fermented type salt-free Miso-like food material with favorable flavor can be produced having strong umami, rich taste, thickness and mouthfullness, to which an odor of brewing is imparted, or in which a stuffy smell or an astringent taste is reduced. Moreover, it was also found that by adding Miso to the salt-free Miso-like food material, the stuffy smell or astringent taste of the rapid fermented type Miso-like food material can be reduced.

Thus, the present invention provides the following:

(1) A method for producing a rapid fermented type Miso-like food material, which method comprises:

(a) adding a Koji mold and a bacteriocin-producing lactic acid bacterium culture fluid or a supernatant thereof to a food material, to obtain a first mixture;

(b) making Koji from said mixture in a hermetically sealed Koji-making machine while continuously or intermittently supplying clean air, to obtain Koji;

(c) mixing a bacteriocin-producing lactic acid bacterium culture fluid or the supernatant thereof with said Koji, and further mixing one or more food materials as needed in an amount of 0.01 to 50 times weight of the Koji, to obtain a second mixture;

(d) forming a moromi-mash by making a paste from said second mixture; and

(e) hydrolyzing said moromi-mash in the substantially absence of common salt, to obtain a hydrolyzed moromi-mash.

(2) The method according to (1), wherein an alcoholic liquor and/or dextrin is further mixed with said Koji in the step (c).

(3) The method according to (1) or (2), wherein yeast is further added to said first mixture in the step (a) or to said Koji in step (c).

(4) The method according to any one of (1) to (3), further comprising:

(f) mixing an alcoholic liquor with said moromi-mash before said hydrolyzing or with said hydrolyzed moromi-mash.

(5) The method according to any one of (1) to (4), wherein said food material in step (a) and/or step (c) is at least one food material selected from the group consisting of soybean, Japanese common chestnut, mung bean, rice, faba bean, and mixtures thereof.

(6) The method according to any one of (1) to (5), wherein said bacteriocin-producing lactic acid bacterium is a nisin-producing lactic acid bacterium.

(7) The method according to any one of (1) to (6), wherein said clean air is air which is sterilized by a filter that can collect 99.97% or more of the dust being 0.3 μm or greater.

(8) A Miso-like food material, which is produced by a method according to any one of (1) to (7).

(9) A method for making a rapid fermented type Miso-like food material, which method comprises:

adding Miso produced by a traditional method to a rapid fermented type Miso-like food material produced by a method according to any one of (1) to (7).

(10) A Miso-like food material, which is produced by a method according to (9).

The present invention is advantageous in that: a novel salt-free Miso-like food material with favorable flavor can be produced having a strong umami, rich taste, thickness and mouthfullness, to which an odor of brewing is imparted, or in which a stuffy smell or an astringent taste is reduced, in a simple and inexpensive apparatus and in a shorter period of fermentation and aging than common Miso, because the enzyme activity such as protease and peptidase in the Koji mold is not inhibited by common salt, and thus, a sense of well-being is provided due to being salt free.

### DETAILED DESCRIPTION OF THE PREFERRED EMBODIMENTS

In the present invention, soybean, rice, wheat, or barley which may be used in common Miso as well as a bean such as faba bean or mung bean, a cereal such as corn, or Japanese common chestnut can be used as the food material to which the Koji mold is added (the food material to which the Koji mold is added is sometimes hereinafter referred to as “Koji material”), and the food material for forming the moromi-mash by addition to the Koji (moromi-mash material). However, in order to obtain the Miso-like food material, it is desired that either one of the Koji material or the moromi-mash material is any one of soybean, Japanese common chestnut, mung bean, and faba bean. Among them, when any one of Japanese common chestnut, faba bean, and peeled mung bean is used, the odor and flavor of the resulting Miso-like food material can be favorable. These materials for foods may be also subjected to any pretreatment such as an immersing treatment in water, a peeling treatment or chopping treatment, or any heat treatment such as steam boiling treatment or roasting treatment, as needed.

A culture fluid or a supernatant thereof of a lactic acid bacterium capable of producing bacteriocin, that is an antimicrobial substance, and a Koji mold is mixed with the afore-mentioned Koji material, and thereto can be supplied clean air, followed by charging the mixture into a Koji-making machine which can be sealed hermetically. The Koji-making machine into which clean air can be supplied and which can be sealed hermetically may be one having a function to supply clean air into the Koji-making equipment and having a structure to enable the inside of the Koji-making equipment to be blocked from the outside air. Examples of such a Koji-making machine include, e.g., rotary drum type Koji-making machines, but Koji-making machines having a structure that enable clean air to be supplied into the Koji-making machine, and have an openable and closable lid which can achieve a hermetically sealed state are more preferred, because they are more simple and inexpensive. The method for sterilizing the air may be one in which a filter is used that can collect 99.97% or more dust being 0.3 μm or greater, for example, a HEPA filter or the like. To the exhaust opening of the Koji-making equipment must be attached a filter for blocking the outside air. The Koji-making equipment which can not be sealed hermetically, for example, a rotary disc type Koji-making machine, a standing ventilation type Koji-making machine, or the like may not avoid any contamination with the microorganisms from the outside air. In particular, contamination with lactic acid bacteria such as bacteria belonging to the genus Pediococcus and bacteria belonging to the genus Enterococcus may occur, and in some cases, lactic acid is produced during the aging, which may lead to what is generally referred to as souring. The method for the ventilation is not particularly limited, but internal ventilation, surface ventilation, or the like may be employed.

With respect to the culture fluid or the supernatant thereof of the lactic acid bacterium, for example, one having a nisin activity of not lower than 20 IU/ml, preferably not lower than 200 IU/ml may be added in an amount of 0.0001 to 0.2 times by weight, preferably 0.001 to 0.1 times by weight, more preferably 0.01 to 0.05 times by weight, of the Koji material. When the amount is less than 0.0001 times by weight, the antimicrobial action is inferior, and thus, contamination with saprophytic bacteria may not be avoided. As a matter of course, the amount of addition of the culture fluid or the supernatant thereof of the lactic acid bacterium can be changed depending on the nisin activity. Additionally, when the amount is beyond 0.2 times by weight of the Koji material, the moisture content of the mixture may be so high that an adverse effect may be exerted on the growth of the Koji mold. Examples of the bacteriocin produced by the lactic acid bacterium include, in addition to nisin, pediocin, sakacin, nukacin, and the like. Among these, nisin is desirably used in light of its broad antimicrobial spectrum. In this instance, the type of the nisin produced by the lactic acid bacterium may be any of nisin A, nisin Z, and derivatives thereof. In order for the contamination and proliferation of the microorganism to be prevented, a higher bacteriocin activity in the lactic acid bacterium culture fluid or the supernatant thereof used is desired. Thus, for example, Lactococcus lactis AJ110212 (FERM BP-8552) or the like that strongly produces nisin Z can be used. The L. lactis AJ110212 strain was deposited at National Institute of Advanced Industrial Science and Technology, Patent Microorganisms Depositary on Nov. 19, 2003 under an Accession Number of FERM BP-8552.

The Koji mold which may be used in the present invention desirably can degrade the protein material into amino acids and peptides to a high degree, to thereby impart a strong umami, rich taste, thickness and mouthfullness to the resulting novel Miso-like food material, but is not particularly limited. For example, any Koji mold belonging to genus Aspergillus such as Aspergillus oryzae and Aspergillus sojae employed for Miso can be used. Additionally, any Koji mold belonging to genus Monascus such as Monascus anka used for manufacturing tofuyo (fermented soybean curd) made in Okinawa, any Koji mold belonging to genus Neurospora such as Neurospora sitophila used in a fermented food, Onchom (or ontjom), or any Koji mold belonging to genus Rhizopus such as Rhizopus oryzae used in a fermented food Tempe can be also used. When a Koji mold belonging to genus Monascus, a Koji mold belonging to genus Neurospora, or a Koji mold belonging to genus Rhizopus is used, an odor of brewing can be imparted to the resulting Miso-like food material, therefore, a Miso-like food material having favorable flavor can be obtained. The amount of addition of the Koji mold is not particularly limited, but for example, 0.01 to 10% by weight per the amount of the Koji material is preferred.

After charging a mixture of the Koji material, the lactic acid bacterium culture fluid or the supernatant thereof, and the Koji mold into the Koji-making equipment, the Koji-making is carried out in a state of the Koji-making equipment being sealed hermetically at a temperature of 20 to 40° C. for a time of 17 to 62 hours, preferably at 24 to 34° C. for 40 to 55 hours, and more preferably for 40 to 49 hours to obtain Koji. When the Koji making temperature is above 40° C., the enzyme activity required for degradation of the protein material may be too low, while a temperature of lower than 20° C. may result in insufficient growth of the Koji mold. In either case, the enzyme required for degradation of the protein material may not be obtained in a sufficient amount, therefore, the novel Miso-like food material having a sufficient umami, rich taste, thickness, and mouthfullness may not be obtained. In addition, when the Koji making time period is shorter than 17 hours, it is difficult to sufficiently grow the Koji mold, therefore, the novel Miso-like food material having a sufficient umami, rich taste, thickness, and mouthfullness may not be obtained. When a shortening of the Koji making time period is intended, it is desired to predetermine the Koji making temperature to be 34 to 40° C. for increasing the growth rate of the Koji. Furthermore, when the Koji making time period is longer than 62 hours, the enzyme activity required for degradation of the protein material may be so low that a sufficient umami, rich taste, thickness, and mouthfullness may not be achieved, but bitterness may be imparted. When the Koji making time period is prolonged, it is desired to predetermine the Koji making temperature to be 20 to 30° C. for decreasing the growth rate of the Koji.

Next, the culture fluid or the supernatant thereof of the lactic acid bacterium that produces bacteriocin such as nisin is added to thus resulting Koji in an amount of 0.01 to 5 times by weight, preferably 0.1 to 1 time by weight, of the Koji such that the moisture content of the moromi-mash becomes 35 to 60% by weight, and preferably 40 to 50% by weight. Thereto is added one or more materials for foods in an amount of 0.01 to 50 times by weight of the Koji as needed to form the moromi-mash. Herein, the term “as needed” means that when a bean Koji is made with a soybean, there may be a case in which the soybean may not be added again in forming the moromi-mash. More specifically, when a soybean is used as the material of the Koji, the lactic acid bacterium culture fluid or the supernatant thereof is added again to the Koji made from the mixture including the soybean, the lactic acid bacterium culture fluid or the supernatant thereof and the Koji mold, to thereby form the moromi-mash. Also, to the Koji may be added a food material such as, e.g., soybean, rice, wheat or barley, or the like. In this case, the material may be used after having been subjected to steam boiling, or roasting beforehand. For example, when rice Koji or Mugi (wheat or barley) Koji each material of which being rice, or wheat or barley is used as the material of the Koji, a soybean previously subjected to steam boiling or roasting can be added thereto. Alternatively, when a bean Koji is used, wheat or barley, or rice previously subjected to steam boiling or roasting can be added thereto. As described above, for obtaining the Miso-like food material, either one of the Koji material or the moromi-mash material may be desirably any one of soybean, Japanese common chestnut, mung bean, and faba bean. Moreover, extract of each plant material, or a particular component thereof may be added thereto. For example, soybean extract, rice starch, wheat bran, and the like may be exemplified. Furthermore, color, as well as taste, flavor, and the like can be controlled depending on the type and the amount of addition of this material for foods. For example, sweetness can be imparted by adding rice. The addition of the lactic acid bacterium culture fluid or the supernatant thereof, and the materials for foods such as rice and the alcoholic liquor to the Koji may be in any order. Hence, the addition of the material for foods to the Koji may be any of before, after, or during the addition of the lactic acid bacterium culture fluid or the supernatant thereof to the Koji.

Moreover, by adding the alcoholic liquor, yeast, and dextrin to the resulting Koji, a Miso-like food material having an odor of brewing imparted thereto, with reduced stuffy smell or astringent taste can be obtained. The alcoholic liquor to be added is preferably rice wine (sake), distilled spirit (shochu), or white wine, and the amount of addition of the alcoholic liquor may be preferably determined so that the alcohol content of the moromi-mash becomes 0.5 to 5% by weight. The alcoholic liquor may be added to the Koji, or may be added to the moromi-mash after forming into the paste but before the hydrolysis, or to the moromi-mash after the hydrolysis. When yeast is added, any yeast for beer such as Saccharomyces uvarum, any yeast for sake such as Schizosaccharomyces pombe var iotoensis, or any yeast for early aging of soy sauce such as Zygosaccharomyces rouxii may be preferred. The yeast may be added to the Koji material prior to the Koji making, but it is more preferred to add to the Koji after completing the Koji making. The amount of addition of the yeast is preferably 10⁵ to 10⁹ cells, and more preferably 10⁷ cells, per gram of the moromi-mash. When dextrin is added, any dextrin derived from tapioca such as “TK-16” or “TK-75” manufactured by Matsutani Chemical Industry Co., Ltd., or any dextrin derived from corn such as “SANDEC #70” manufactured by SANWA CORNSTARCH CO., LTD. is preferred. The amount of the addition of the dextrin is preferably 5 to 30% by weight, and more preferably 10 to 20% by weight, per the total weight of the moromi-mash.

When the amount of the addition of the lactic acid bacterium culture fluid or the supernatant thereof is less than 0.01 times by weight, suppression of proliferation of the microorganisms may not be accomplished, while when the amount is above 5 times by weight, protein degradation may not be sufficient, and thus, the novel Miso-like food material having a sufficient umami, rich taste, thickness, and mouthfullness may not be obtained.

Next, the mixture of the Koji, the one or more materials for foods and the nisin-producing lactic acid bacterium culture fluid or the supernatant thereof is ground with a chopper or the like to make into the paste form to thereby form the moromi-mash. The moromi-mash is incubated at a temperature of 20 to 50° C., preferably 20 to 45° C., more preferably 25 to 35° C., for a time of 1 to 50 days, preferably 3 to 30 days, more preferably 4 to 14 days, and still more preferably 4 to 9 days, so as to allow for the fermentation and aging to permit hydrolysis. When the temperature is lower than 20° C., the degradation of the protein may not be sufficient, and thus, the novel Miso-like food material having a sufficient umami, rich taste, thickness, and mouthfullness may not be obtained. Additionally, a temperature above 50° C. is not preferred, because sugar and amino acids included in the moromi-mash may react to impart browning odor, burnt odor and bitterness to the novel Miso-like food material. The same may be applied to the time period of the aging. When the time period is shorter than 24 hours, the degradation of the protein may not be sufficient, and thus, the novel Miso-like food material having a sufficient umami, rich taste, thickness and mouthfullness may not be obtained. Moreover, a time period of 50 days or longer is not preferred, because sugar and amino acids included in the moromi-mash may react to impart a browning odor, burnt odor and bitterness to the novel Miso-like food material. Additionally, in light of the prevention of contamination with saprophytic bacteria, the hydrolysis of the moromi-mash is more preferably carried out in a closed system, e.g., through filling and packing of the moromi-mash in a laminated pouch, a plastic vessel, or the like.

Subsequently, if necessary, the moromi-mash after completing the aging and hydrolysis is heated at a temperature of 50 to 130° C. for a time of 1 to 150 minutes. The heating is performed for the purpose of pasteurization and deactivation of the enzyme such as protease included in the moromi-mash to decrease alteration of the quality during storage. The method of the heating is not limited, but for example, a double tube type heating machine, a multiple tube type heating machine or the like for use in heat-sterilizing (hi-ire) of the Miso can be used, or a hot-water bath can be also used after filling and packing the moromi-mash in a pouch or the like. When the temperature is lower than 50° C., pasteurization and inactivation of the enzyme may not be sufficient, while a temperature above 130° C. is not preferred because a browning odor, burnt odor and bitterness may be imparted. The same may be applied to the time period. When the time period is shorter than 1 minute, pasteurization and inactivation of the enzyme may not be sufficient, while a time period of longer than 150 minutes is not preferred because a browning odor, burnt odor and bitterness may be imparted.

The Miso-like food material obtained according to the method of the present invention can be used directly in the form of the paste. However, it can also be used in the form of powder after drying with a spray drier, a drum drier, a vacuum drum drier, a freeze drier, or the like.

The Miso-like food material obtained according to the method of the present invention is salt free, and has a strong umami, rich taste, thickness, and mouthfullness, with a reduced stuffy smell or astringent taste. Therefore, it can be used not only for miso soup but for a variety of foods and drinks extensively. In the case of Miso, it cannot be consumed in large quantity due to the salinity included therein. In contrast, because the present Miso-like food material is salt free, it can be consumed in large quantity with the healthy function involved in the soybean.

Examples of the modes of using the novel Miso-like food material obtained according to the method of the present invention include: (1) modes in which it is used in the manufacture and processing of a variety of foods and drinks; (2) methods in which it is used after blending with a variety of seasonings in the form of a liquid, granules, or powder; (3) modes in which it is directly eaten; and the like.

Moreover, by adding 10 to 200 parts by weight, and preferably 30 to 150 parts by weight of a Miso, such as Shinshu Miso and Sendai Miso, which is manufactured according to a conventional method, to 100 parts by weight of the rapid fermented type Miso-like food material obtained according to the method of the present invention, a preferable odor of brewing can be imparted to the rapid fermented type Miso-like food material, and the stuffy smell or astringent taste can be reduced.

Other features of the invention will become apparent in the course of the following descriptions of exemplary embodiments which are given for illustration of the invention and are not intended to be limiting thereof.

### EXAMPLES

### Example 1

Soybean in an amount of 300 g was immersed in water, and after permitting water absorption, it was subjected to steam boiling in an Autoclave machine at 114° C. for 40 minutes. With the steam boiled soybean were mixed 6 g of an L. lactis AJ110212 (FERM BP-8552) culture fluid (nisin activity: 1000 IU/ml) and 1 g of the mold starter described in Table 1. The mixture was charged in a labo incubator which can be sealed hermetically, and Koji making was carried out at 30° C. for 43 hours in the hermetically sealed state Koji-making machine. For removing the heat of fermentation during the Koji making, clean air was used which had been prepared by filtering through a HEPA filter. Subsequently, rice which was steam dried at 114° C. for 40 minutes and cooled to 30° C. was added to the Koji so that the weight ratio of the Koji: the steam boiled rice became 65: 35. After adding 40.9 g of the L. lactis AJ110212 (FERM BP-8552) culture fluid (nisin activity: 1000 IU/ml) thereto, the mixture was crushed by a chopper to give a paste form. This paste was packed in a laminated pouch so as to include 300 g in one bag. After incubating this pouch at 30° C. for 7 days, a Miso-like food material was prepared. From each Miso-like food material sample was prepared a 10% hot water solution, which was subjected to a sensory evaluation with a sample prepared using an Koji mold for Miso as a control. The results of sensory evaluation are shown in Table 1. As shown in Table 1, the samples in which the Koji mold belonging to the genus Monascus, the Koji mold belonging to the genus Rhizopus or the Koji mold belonging to the genus Neurospora was used exhibited a favorable flavor with an odor of brewing imparted thereto. Additionally, the sample in which Aspergillus tamari was used exhibited a reduced astringent taste.

TABLE 1

| | | Astringent | Stuffy | Odor of |
|---|---|---|---|---|
| Koji mold | Usage | taste | smell | brewing |
| Monuscus anka | Tofuyo | x | ∘ | ∘ |
| Neurospora sitophila | Onchom | ∘ | Δ | ∘ |
| Rhizopus oryzae | Tempe | x | Δ | ∘ |
| Aspergillus niger | Shochu | x | x | x |
| Aspergillus tamari | Soy sauce | Δ | x | x |
| Aspergillus oryzae | Miso | x | x | x |
| (Control) | | | | |

Astringent taste, stuffy smell: ∘: Weaker than Control; Δ: Slightly weaker than Control; and x: Equivalent to Control
Odor of brewing: ∘: Stronger than Control; Δ: Slightly stronger than Control; and x: Equivalent to Control

### Example 2

Soybean in an amount of 300 g was immersed in water, and after permitting water absorption, it was subjected to steam boiling in an Autoclave machine at 114° C. for 40 minutes. With the steam boiled soybean were mixed 6 g of the L. lactis AJ110212 (FERM BP-8552) culture fluid (nisin activity: 1000 IU/ml) and 1 g of a mold starter (manufactured by Bioc Corp., mold starter for Miso). The mixture was charged in a labo incubator which can be sealed hermetically, and Koji making was carried out at 30° C. for 43 hours in the hermetically sealed state Koji-making machine. For removing the heat of fermentation during the Koji making, clean air was used which had been prepared by filtering through a HEPA filter. Subsequently, rice which was steam dried at 114° C. for 40 minutes and cooled to 30° C. was added to the Koji so that the weight ratio of the Koji: the steam boiled rice became 65: 35. After adding 40.9 g of the L. lactis AJ110212 (FERM BP-8552) culture fluid (nisin activity: 1000 IU/ml) thereto, any one of various yeast shown in Table 2 was added in an amount of 10⁷ cells per gram of the mixture. The mixture was crushed by a chopper to give a paste form. This paste was packed in a laminated pouch so as to include 300 g in one bag. After incubating this pouch at 30° C. for 7 days, a Miso-like food material was prepared. From each Miso-like food material sample was prepared a 10% hot water solution, which was subjected to the sensory evaluation with the sample which was employed as a control in Example 1 as the control. The results of sensory evaluation are shown in Table 2. As shown in Table 2, the sample in which the yeast for beer, the yeast for sake, or the yeast for early aging of soy sauce was used exhibited a favorable flavor with an odor of brewing imparted thereto and with reduced stuffy smell.

TABLE 2

| | | Astrin- | | |
|---|---|---|---|---|
| | | gent | Stuffy | Odor of |
| Yeast | Usage | taste | smell | brewing |
| Hansenula anomala ver. | Pickles | x | x | x |
| miso J-7095 | | | | |
| Debaromyces miso var. l- | Pickles | x | x | x |
| mogi J-8003 | | | | |
| Saccharomyces uvarum | Beer | x | ∘ | ∘ |
| Schizosaccharomyces pombe | Sake | x | ∘ | ∘ |
| var iotoensis | | | | |
| Zygosaccaromyces rouxii | Early | x | ∘ | Δ |
| | aging of | | | |
| | soy sauce | | | |
| Candida versatilis | Latter | x | x | x |
| | aging of | | | |
| | soy sauce | | | |
| Yeast for Miso | Miso | x | x | x |
| (manufactured by Bioc | | | | |
| Corp.) | | | | |

Astringent taste, stuffy smell: ∘: Weaker than Control; Δ: Slightly weaker than Control; and x: Equivalent to Control
Odor of brewing: ∘: Stronger than Control; Δ: Slightly stronger than Control; and x: Equivalent to Control

### Example 3

Soybean in an amount of 300 g was immersed in water, and after permitting water absorption, it was subjected to steam boiling in an Autoclave machine at 114° C. for 40 minutes. With the steam boiled soybean were mixed 6 g of the L. lactis AJ110212 (FERM BP-8552) culture fluid (nisin activity: 1000 IU/ml) and 1 g of the mold starter (manufactured by Bioc Corp., mold starter for Miso). The mixture was charged in a labo incubator which can be sealed hermetically, and Koji making was carried out at 30° C. for 43 hours in the hermetically sealed state Koji-making machine. For removing the heat of fermentation during the Koji making, clean air was used which had been prepared by filtering through a HEPA filter. Subsequently, rice which was steam dried at 114° C. for 40 minutes and cooled to 30° C. was added to the Koji so that the weight ratio of the Koji: the steam boiled rice became 65: 35. After adding 40.9 g of the L. lactis AJ110212 (FERM BP-8552) culture fluid (nisin activity: 1000 IU/ml) thereto, any one of various alcoholic liquors shown in Table 3 was added such that the alcohol content became 1.4 or 2.8% by weight. The mixture was crushed by a chopper to give a paste form. This paste was packed in a laminated pouch so as to include 300 g in one bag. After incubating this pouch at 30° C. for 7 days the mixture was heated at 80° C. for 40 minutes to prepare a Miso-like food material. From each Miso-like food material sample was prepared a 10% hot water solution, which was subjected to the sensory evaluation with the sample which was employed as a control in Example 1 as the control. The results of sensory evaluation of the sample prepared so as to give the alcohol content of 2.8% are shown in Table 3. As shown in Table 3, the sample to which sake, shochu, or white wine was added exhibited a favorable flavor with an odor of brewing imparted thereto and with a reduced stuffy smell. Although a smaller difference from the control was found in the results of evaluation of the sample prepared so as to give the alcohol content of 1.4%, they were similar to the results shown in Table 3. In addition, also in case of adding each alcoholic liquor to the hydrolyzed moromi-mash, similar results to Table 3 were achieved.

TABLE 3

| | Astrin- | | |
|---|---|---|---|
| | gent | Stuffy | Odor of |
| Alcoholic liquor | taste | smell | brewing |
| Ethanol (Japan Alcohol Trading CO., LTD, | x | Δ | Δ |
| Specified alcohol, proof: 95 degree) | | | |
| Sake (manufactured by Gekkeikan Sake Co., | Δ | Δ | Δ |
| Ltd. Namazake (unpasteurized “draft sake”), | | | |
| Karakuchi (dry type), Kaori Zeitaku | | | |
| (luxurious flavor)) | | | |
| Shochu (manufactured by Takara Shuzo Co., | ∘ | ∘ | ∘ |
| Ltd., Takara Cup, Takara Shochu, Takara) | | | |
| White sake (Kosei Seihin, white sake) | x | x | x |
| Chinese wine (Shanghai Chinese wine) | x | x | x |
| White wine (Pro Japan, Carlo Rossi | Δ | ∘ | ∘ |
| California White) | | | |
| Red wine (Pro Japan Carlo Rossi California | x | x | x |
| Red) | | | |
| Whisky (manufactured by Suntory Limited, | x | x | x |
| Torys Whisky Black) | | | |

Astringent taste, stuffy smell: ∘: Weaker than Control; Δ: Slightly weaker than Control; and x: Equivalent to Control
Odor of brewing: ∘: Stronger than Control; Δ: Slightly stronger than Control; and x: Equivalent to Control

### Example 4

Soybean in an amount of 300 g was immersed in water, and after permitting water absorption, it was subjected to steam boiling in an Autoclave machine at 114° C. for 40 minutes. With the steam boiled soybean were mixed 6 g of the L. lactis AJ110212 (FERM BP-8552) culture fluid (nisin activity: 1000 IU/ml) and 1 g of the mold starter (manufactured by Bioc Corp., mold starter for Miso). The mixture was charged in a labo incubator which can be sealed hermetically, and Koji making was carried out at 30° C. for 43 hours in the hermetically sealed state Koji-making machine. For removing the heat of fermentation during the Koji making, clean air was used which had been prepared by filtering through a HEPA filter. The carbohydrate material shown in Table 4 was added in an amount of 10% by weight or 20% by weight of the Koji. After adding 40.9 g of the L. lactis AJ110212 (FERM BP-8552) culture fluid (nisin activity: 1000 IU/ml) thereto to adjust the moisture of the mixture, the mixture was crushed by a chopper to give a paste form. This paste was packed in a laminated pouch so as to include 300 g in one bag. After incubating this pouch at 30° C. for 7 days, a Miso-like food material was prepared. From each Miso-like food material sample was prepared a 10% hot water solution, which was subjected to the sensory evaluation with the sample which was employed as a control in Example 1 used as the control. The results of sensory evaluation of the sample prepared by adding the carbohydrate material in an amount of 20% by weight of the Koji are shown in Table 4. As shown in Table 4, the sample to which dextrin was added exhibited a favorable flavor with reduced astringent taste. Although a smaller difference from the control was found in the results of evaluation of the sample prepared by adding the carbohydrate material in an amount of 10% by weight of the Koji, they were similar to the results shown in Table 4.

TABLE 4

| | | | Astrin- | | |
|---|---|---|---|---|---|
| | | | gent | Stuffy | Odor of |
| Type | Manufacturer | Material | taste | smell | brewing |
| MD | NIHON | Corn | x | x | x |
| | SHOKUHIN | | | | |
| | KAKO CO., LTD | | | | |
| Purified | Matsutani | Potato | x | x | x |
| and pas- | Chemical | | | | |
| teurized | Industry Co., Ltd. | | | | |
| baden | | | | | |
| Nissyoku | NIHON | Oiled potato | x | x | x |
| Ginrei | SHOKUHIN | | | | |
| | KAKO CO., LTD | | | | |
| Matsu- | Matsutani | Tapioca | x | x | x |
| norin | Chemical | starch | | | |
| M-22 | Industry Co., Ltd. | (gelatinized) | | | |
| Matsu- | Matsutani | Tapioca | x | x | x |
| norin | Chemical | starch | | | |
| 340 | Industry Co., Ltd. | (gelatinized) | | | |
| Lactose | Lino Saputo | Cheese whey | x | x | x |
| edible | | | | | |
| SANDEC | SANWA | Corn | Δ | x | x |
| #70 | CORNSTARCH | | | | |
| | CO., LTD. | | | | |
| TK16 | Matsutani | Tapioca | ∘ | x | x |
| | Chemical | | | | |
| | Industry Co., Ltd. | | | | |
| TK75 | Matsutani | Tapioca | ∘ | x | x |
| | Chemical | | | | |
| | Industry Co., Ltd. | | | | |
| HL-PDX | Matsutani | Tapioca | ∘ | x | x |
| | Chemical | | | | |
| | Industry Co., Ltd. | | | | |
| SE-100 | Matsutani | Corn | Δ | x | x |
| | Chemical | | | | |
| | Industry Co., Ltd. | | | | |

Astringent taste, stuffy smell: ∘: Weaker than Control; Δ: Slightly weaker than Control; and x: Equivalent to Control
Odor of brewing: ∘: Stronger than Control; Δ: Slightly stronger than Control; and x: Equivalent to Control

### Example 5

Each food material shown in Table 5 in an amount of 300 g was immersed in water, and after permitting water absorption, it was subjected to steam boiling in an Autoclave machine at 114° C. for 40 minutes. Therewith were mixed 6 g of the L. lactis AJ110212 (FERM BP-8552) culture fluid (nisin activity: 1000 IU/ml) and 1 g of the mold starter (manufactured by Bioc Corp., mold starter for Miso). The mixture was charged in a labo incubator which can be sealed hermetically, and Koji making was carried out at 30° C. for 43 hours in the hermetically sealed state Koji-making machine. For removing the heat of fermentation during the Koji making, clean air was used which had been prepared by filtering through a HEPA filter. After adding 40.9 g of the L. lactis AJ110212 (FERM BP-8552) culture fluid (nisin activity: 1000 IU/ml) to this Koji, the mixture was crushed by a chopper to give a paste form. This paste was packed in a laminated pouch so as to include 300 g in one bag. After incubating this pouch at 30° C. for 7 days, a Miso-like food material was prepared. From each Miso-like food material sample was prepared a 10% hot water solution, which was subjected to the sensory evaluation with the sample which was employed as a control in Example 1 used as the control. The results of sensory evaluation of the sample prepared by adding the carbohydrate material in an amount of 20% by weight of the Koji are shown in Table 5. As shown in Table 5, the Miso-like food material prepared from faba bean, Japanese common chestnut or peeled mung bean exhibited a favorable taste and flavor.

TABLE 5

| | Astringent | | Odor of |
|---|---|---|---|
| Material | taste | Stuffy smell | brewing |
| Black bean | x | x | x |
| Faba bean | Δ | ∘ | ∘ |
| Adzuki bean (red bean) | x | x | x |
| Kidney bean | x | x | x |
| Green pea | x | x | x |
| Black-eyed bean (cowpea) | x | x | x |
| Lentil | x | x | x |
| Japanese common chestnut | ∘ | Δ | Δ |
| Peanut | x | x | x |
| Peeled mung bean | ∘ | Δ | ∘ |
| Pea | x | x | x |
| Colored kidney bean | x | x | x |

Astringent taste, stuffy smell: ∘: Weaker than Control; Δ: Slightly weaker than Control; and x: Equivalent to Control
Odor of brewing: ∘: Stronger than Control; Δ: Slightly stronger than Control; and x: Equivalent to Control

### Example 6

A 10% hot water solution was prepared from a sample of a mixture of 1 part by weight of the sample employed as the control in Example 1 with 1 part by weight of commercially available Sendai Miso or Shinshu Miso, and the sensory evaluation was performed with the sample employed as the control in Example 1. An odor of brewing was imparted to the sample prepared by mixing the commercially available Miso, while the stuffy smell and astringent taste was reduced.

### INDUSTRIAL APPLICABILITY

The novel Miso-like food material of the present invention can be used in seasoning applications and as a food material through utilizing the strong umami, rich taste, thickness and mouthfullness, and thus, can be used extensively in processed foods including various seasonings such as sauces for dipping and mop sauces and the like as well as confectioneries. Therefore, the invention is extremely useful in industry, particularly in food field.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method for producing a rapid fermented type Miso-like food material, which method comprises:
(a) adding a Koji mold and a bacteriocin-producing lactic acid bacterium culture fluid or a supernatant thereof to a food material, to obtain a first mixture;
(b) making Koji from said mixture in a hermetically sealed Koji-making machine while continuously or intermittently supplying clean air, to obtain Koji;
(c) mixing a bacteriocin-producing lactic acid bacterium culture fluid or the supernatant thereof with said Koji, and further mixing one or more food materials as needed in an amount of 0.01 to 50 times weight of the Koji, to obtain a second mixture;
(d) forming a moromi-mash by making a paste from said second mixture; and
(e) hydrolyzing said moromi-mash in the substantially absence of common salt, to obtain a hydrolyzed moromi-mash.

2. The method according to claim 1, wherein an alcoholic liquor and/or dextrin is further mixed with said Koji in the step (c).

3. The method according to claim 1, wherein yeast is added to said first mixture.

4. The method according to claim 1, wherein yeast is added to said Koji in step (c).

5. The method according to claim 1, further comprising:
(f) mixing an alcoholic liquor with said moromi-mash before said hydrolyzing.

6. The method according to claim 1, further comprising:
(f′) mixing an alcoholic liquor with said hydrolyzed moromi-mash.

7. The method according to claim 1, wherein said food material used in step (a) is at least one food material selected from the group consisting of soybean, Japanese common chestnut, mung bean, rice, faba bean, and mixtures thereof.

8. The method according to claim 1, wherein said food material used in step (c) is at least one food material selected from the group consisting of soybean, Japanese common chestnut, mung bean, rice, faba bean, and mixtures thereof.

9. The method according to claim 1, wherein said bacteriocin-producing lactic acid bacterium is a nisin-producing lactic acid bacterium.

10. The method according to claim 1, wherein said clean air is air which is sterilized by a filter that can collect 99.97% or more of the dust being 0.3 μm or greater.

11. A Miso-like food material, which is produced by a method according to claim 1.

12. The Miso-like food material according to claim 11, wherein an alcoholic liquor and/or dextrin is further mixed with said Koji in the step (c).

13. The Miso-like food material according to claim 11, wherein yeast is added to said first mixture.

14. The Miso-like food material according to claim 11, wherein yeast is added to said Koji in step (c).

15. The Miso-like food material according to claim 11, further comprising:
(f) mixing an alcoholic liquor with said moromi-mash before said hydrolyzing.

16. The Miso-like food material according to claim 11, further comprising:
(f′) mixing an alcoholic liquor with said hydrolyzed moromi-mash.

17. The Miso-like food material according to claim 11, wherein said food material used in step (a) is at least one food material selected from the group consisting of soybean, Japanese common chestnut, mung bean, rice, faba bean, and mixtures thereof.

18. The Miso-like food material according to claim 11, wherein said food material used in step (c) is at least one food material selected from the group consisting of soybean, Japanese common chestnut, mung bean, rice, faba bean, and mixtures thereof.

19. The Miso-like food material according to claim 11, wherein said bacteriocin-producing lactic acid bacterium is a nisin-producing lactic acid bacterium.

20. The Miso-like food material according to claim 11, wherein said clean air is air which is sterilized by a filter that can collect 99.97% or more of the dust being 0.3 μm or greater.

21. A method for making a rapid fermented type Miso-like food material, which method comprises:
adding Miso produced by a traditional method to a rapid fermented type Miso-like food material produced by a method according to claim 1.

22. A Miso-like food material, which is produced by a method according to 21.
